(19) United States
(12) Patent Application Publication
(10) Pub. No.: US 2009/0064429 A1
(43) Pub. Date: Mar. 12, 2009

(54) PROTECTIVE HOUSING WITH INTERIOR DECORATIVE SLEEVE MEMBER FOR A POWER ORAL CARE APPLIANCE

(75) Inventors: Scott E. Hall, Issaquah, WA (US); Craig K. Black, Bellevue, WA (US); Simon J. Lamason, Utrecht (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 11/814,197

(22) PCT Filed: Jun. 27, 2005
(86) PCT No.: PCT/IB2005/052117

§ 371 Date: Oct. 28, 2008

Related U.S. Application Data
(60) Provisional application No. 60/583,975, filed on Jun. 29, 2004.

(51) Int. Cl. A46B 13/02; A61C 17/00

(52) U.S. Cl. 15/22.1; 433/131

(57) ABSTRACT

An oral care appliance, includes a handle portion and attachable to the handle portion. toothbrush is positioned within such as a power toothbrush a head portion which is A driving assembly for the handle portion. The handle portion includes an exterior transparent protective housing which satisfies conventional environmental and consumer tests and requirements, and an interior sleeve member adapted to receive the driving assembly and which fits within the transparent housing and is visible therethrough. The interior sleeve member is clearly differentiated from other sleeve members by means of a visual component, such as color or surface texture, thus providing a ready differentiation between otherwise similar or the same toothbrushes.

### TECHNICAL FIELD

This invention relates generally to a power oral care appliance, such as a toothbrush, and more specifically concerns a housing for such an appliance.

### BACKGROUND OF THE INVENTION

Power toothbrushes, as one example of an oral care appliance, typically include a handle portion and a brushhead portion which extends from the handle, the brushhead portion in turn typically including a stem and a brush portion comprising bristles and a bristle plate. The handle portion typically includes a drive assembly and batteries, mounted in a housing, which also includes an on/off switch. The housing is conventionally made from a material such as ABS or polypropylene, which has satisfied various test requirements for such a member, as well as satisfying rigorous environmental and durability requirements for commercial use. There are typically significant chemical and structural requirements and tests which must be met by the external housing of such an appliance.

It is desirable to be able to clearly differentiate between similar toothbrushes, such as for instance within a particular family, which might have two or more separate toothbrushes. Labels or other tag-like elements produce only a relatively minor/superficial differentiation. Using different housings to accomplish the differentiation, such as by use of different colors, textures, etc. would require substantial testing and tooling for each variation. This is a significant burden and hence is not economical.

Accordingly, it would be desirable to have a housing arrangement in which the same or similar toothbrushes could be readily distinguished/differentiated from each other in a significant, decorative manner, provided by the manufacturer.

### SUMMARY OF THE INVENTION

Accordingly, the present invention is a handle housing portion for a power oral care appliance which includes a head portion which is attachable to the handle and a driving assembly positioned within the handle, comprising: a sleeve member which is adapted to receive a toothbrush driving assembly for mounting therein; and an exterior housing which is transparent over a substantial portion thereof, into which the sleeve member is fitted, wherein the sleeve portion includes a visible component which can be easily differentiated from other sleeve members and which is visible through the transparent housing.

### BRIEF DESCRIPTION OF THE DRAWINGS

FIG. 1 is an exploded view of a power toothbrush which incorporates the present invention.

### BEST MODE FOR CARRYING OUT THE INVENTION

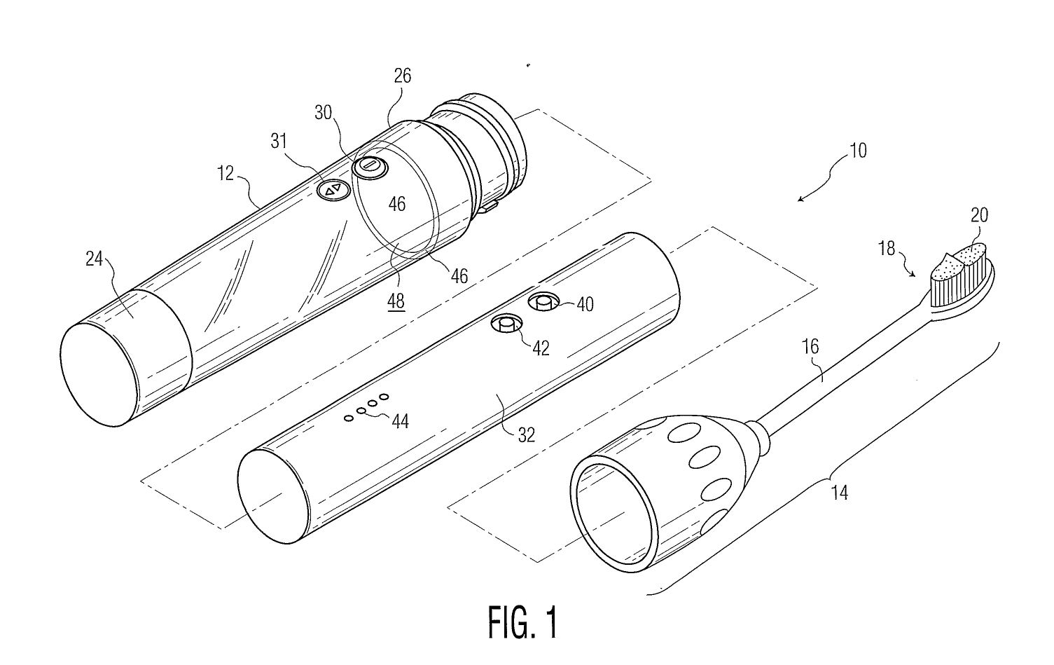

One embodiment of a power toothbrush using the present invention is shown in FIG. 1, generally at 10. The embodiment includes an exterior handle housing 12 and a head portion 14. The head portion 14 connects to the handle portion 12 by any one of various means, such as a screw-on connection. The head portion 14 includes a brushhead stem 16 and a brush portion 18, which in turn includes a set of bristles 20 for cleaning the teeth. Other workpieces could, of course, be substituted for the bristles to produce teeth cleaning.

Conventionally, the handle portion of a power toothbrush includes a drive system for the toothbrush, which moves the brush portion through a particular range of motion to clean the teeth. Various drive systems for such a toothbrush are well-known.

In the present invention, exterior housing 12 is transparent over most of its length, except for small portions 24 and 26 at the respective ends of housing 12, which in the embodiment shown are opaque. In the embodiment shown, portion 24 is approximately 10 mm wide, while portion 26 is 15 mm wide. In the embodiment shown, housing 12 includes a conventional, molded on/off switch 30 and a molded control switch 31, which operates with the drive circuitry to change the speed of the brush portion.

The material of housing 12 is otherwise conventional, fully tested, satisfying all environmental and use requirements, and able to withstand the rigors of conventional commercial use.

The embodiment shown of the present invention also includes a decorative sleeve member 32 which fits inside of housing 12. Sleeve member 32 is made from material which does not need to satisfy the testing and use requirements of housing 16. It can be a wide range of materials, such as various metals, plated plastic or painted plastic, at the choice of the manufacturer, without having to satisfy high use standards, such as being chemically resistant or wear resistant. It can be changed/interchanged by the manufacturer conveniently, as desired.

The sleeve member is used to clearly differentiate one toothbrush from another. This can be done through the use of different colors or other different visual characteristics, including surface appearance, other than color, and/or a different material or material appearance, such as lacquer, various plating treatments, or other variations. The visual characteristics, however, should be such as to provide a ready and easily discernible differentiation for the user, readily visible through the transparent outer housing 12. The sleeve member can also be arranged to produce a light diffusing/conducting effect.

The drive assembly for the toothbrush is mounted within cosmetic sleeve portion 32, similar to how it would be mounted in housing 12 in a conventional toothbrush.

The cosmetic sleeve 32 includes in the embodiment shown two openings 40, 42 along its length. This allows the mechanical on/off and control switches which control the internal drive mechanism to protrude through sleeve 32 for contact with the molded switches 30 and 31 on the external housing 12. The openings are hidden behind the opaque molded switch membranes 30 and 31.

In some cases, a particular toothbrush may include an indicator of battery strength, such as by a series of lights 44. This series of lights can be conveniently mounted on the cosmetic sleeve 32 and connected to internal circuitry, or sleeve 32 could have an opening which exposes lights on the internal circuitry. The lights 44 are conveniently visible to the user because of the transparent exterior housing 12.

The cosmetic sleeve 32 is conveniently connected to exterior housing 12 in a rattle-free arrangement. This can be done in various ways, including snap-fittings or raised contact elements 46 spaced on the interior surface 48 of exterior housing 12. When the toothbrush is assembled, the cosmetic sleeve 32 with the internal drive assembly mounted therein is inserted into housing 12, producing a pressure-fit between the exterior surface of cosmetic sleeve 32 and the several contact elements 46 on the interior surface of transparent housing 12. The arrangement is secure, and there is no rattle of sleeve 32 in housing 12. The head portion is then connected to the exterior housing 12 in conventional fashion, and the toothbrush is ready for use.

Accordingly, a new toothbrush housing has been disclosed which includes a transparent external handle housing and an internal cosmetic housing which can be used to easily and readily differentiate the same or similar toothbrushes from each other in a pleasing, commercially acceptable manner.

Although a preferred embodiment of the invention has been disclosed for purposes of illustration, it should be understood that various changes, modifications and substitutions may be incorporated in the embodiment without departing from the spirit of the invention which is defined by the claims which follow.

What is claimed is:

1. A handle housing portion for a power oral care appliance which includes a head portion which is attachable to the handle and a driving assembly positioned within the handle, comprising:
a sleeve member which is adapted to receive a toothbrush driving assembly for mounting therein; and
an exterior housing which is transparent over a substantial portion thereof, into which the sleeve member is fitted, wherein the sleeve portion includes a visible component which can be easily differentiated from other sleeve members and which is visible through the transparent housing.

2. The housing portion of claim 1, wherein the oral cleaning appliance is a toothbrush.

3. The housing portion of claim 1, wherein the exterior housing satisfies environmental testing and use requirements.

4. The housing portion of claim 2, wherein the visual component of the sleeve member is decorative.

5. The housing portion of claim 3, wherein the decorative component is color.

6. The housing portion of claim 3, wherein the decorative component is external texture.

7. The housing portion of claim 1, wherein the sleeve member is metallic.

8. The housing portion of claim 2, wherein the sleeve member is arranged so as to diffuse or conduct light from the appliance.

9. A toothbrush, comprising:
a head portion; and
a handle housing portion which is attachable to the head portion with a driving assembly positioned within the handle housing portion, the handle housing portion including a sleeve member which is adapted to receive the toothbrush driving assembly for mounting therein and an exterior housing which is transparent over a substantial portion thereof, into which the sleeve member is fitted, wherein the sleeve portion includes a visible component which can be easily differentiated from other sleeve members and which is visible through the transparent housing.
